(19) United States
(12) Patent Application Publication
(10) Pub. No.: US 2022/0383771 A1
(43) Pub. Date: Dec. 1, 2022

(54) SYSTEMS AND METHODS FOR CONTEXTUAL PARTICIPATION FOR REMOTE EVENTS

(71) Applicant: AT&T Intellectual Property I, L.P., Atlanta, GA (US)

(72) Inventors: Louis Alexander, Franklin, NJ (US); Jianxiong Dong, Pleasanton, CA (US); Prateek Baranwal, Dallas, TX (US); Eric Zavesky, Austin, TX (US)

(73) Assignee: AT&T Intellectual Property I, L.P., Atlanta, GA (US)

(21) Appl. No.: 17/334,209

(22) Filed: May 28, 2021

(51) Int. Cl. G09B 19/00; H04N 7/14; G09B 5/02; G09B 5/06; G06N 20/00; G06N 5/04

(52) U.S. Cl. CPC G09B 19/003; H04N 7/147; G09B 5/02; G09B 5/065; G06N 20/00; G06N 5/04

(57) ABSTRACT

Aspects of the subject disclosure may include, for example, engaging in first communications between a device and a first user device, the first communications comprising a first visual representation sent from the first user device to the device of first actions performed by a first user; engaging in second communications between the device and a second user device, the second communications comprising a second visual representation sent from the second user device to the device of second actions performed by a second user, the second communications occurring substantially simultaneously with the first communications; making a first determination via machine learning, based at least in part upon the first visual representation, whether performance of a first task by the first user has been completed; making a second determination via the machine learning, based at least in part upon the second visual representation, whether performance of the first task by the second user has been completed; responsive to the first determination being that the performance of the first task by the first user has been completed, prompting an instructor to provide an indication of a next task to be performed by the first user; and responsive to the second determination being that the performance of the first task by the second user has not been completed, prompting the instructor to provide additional instructions to the second user to aid the second user in performing the first task. Other embodiments are disclosed.

### FIELD OF THE DISCLOSURE

The subject disclosure relates to systems and methods for contextual participation for remote events.

### BACKGROUND

In increasingly connected interactions, the synchronization of remote and local participants has become more challenging. Specifically, in cases where there are multiple local users to one remote user (potentially an expert), addressing individual needs may conventionally be disruptive to the overall event or impossible for specific local problem solving.

### BRIEF DESCRIPTION OF THE DRAWINGS

Reference will now be made to the accompanying drawings, which are not necessarily drawn to scale, and wherein:

FIG. 1 is a block diagram illustrating an example, non-limiting embodiment of a communication network in accordance with various aspects described herein.

FIG. 2A is a block diagram illustrating an example, non-limiting embodiment of a system (which can function, for example, fully or partially within the communication network of FIG. 1) in accordance with various aspects described herein.

FIG. 2B is a block diagram illustrating an example, non-limiting embodiment of a system (which can function, for example, fully or partially within the communication network of FIG. 1) in accordance with various aspects described herein.

FIG. 2C is a block diagram illustrating an example, non-limiting embodiment of a system (which can function, for example, fully or partially within the communication network of FIG. 1) in accordance with various aspects described herein.

FIG. 2D is a block diagram illustrating an example, non-limiting embodiment of a system (which can function, for example, fully or partially within the communication network of FIG. 1) in accordance with various aspects described herein.

FIG. 2E depicts an illustrative embodiment of a method in accordance with various aspects described herein.

FIG. 2F depicts an illustrative embodiment of a method in accordance with various aspects described herein.

FIG. 2G depicts an illustrative embodiment of a method in accordance with various aspects described herein.

FIG. 3 is a block diagram illustrating an example, non-limiting embodiment of a virtualized communication network in accordance with various aspects described herein.

FIG. 4 is a block diagram of an example, non-limiting embodiment of a computing environment in accordance with various aspects described herein.

FIG. 5 is a block diagram of an example, non-limiting embodiment of a mobile network platform in accordance with various aspects described herein.

FIG. 6 is a block diagram of an example, non-limiting embodiment of a communication device in accordance with various aspects described herein.

### DETAILED DESCRIPTION

The subject disclosure describes, among other things, illustrative embodiments for enabling, during a remote event, contextual participation (e.g., provision of expert help and/or advice). Other embodiments are described in the subject disclosure.

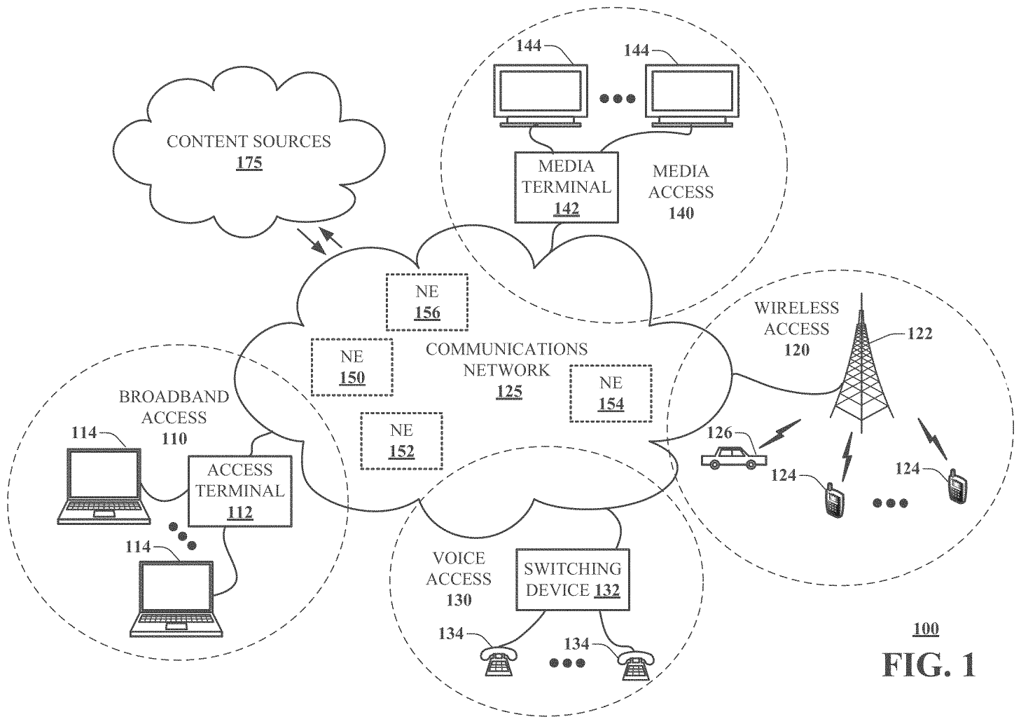

Referring now to FIG. 1, a block diagram is shown illustrating an example, non-limiting embodiment of a system 100 in accordance with various aspects described herein. For example, system 100 can facilitate in whole or in part providing contextual participation (e.g., expert help and/or advice) for remote events. In particular, a communications network 125 is presented for providing broadband access 110 to a plurality of data terminals 114 via access terminal 112, wireless access 120 to a plurality of mobile devices 124 and vehicle 126 via base station or access point 122, voice access 130 to a plurality of telephony devices 134, via switching device 132 and/or media access 140 to a plurality of audio/video display devices 144 via media terminal 142. In addition, communications network 125 is coupled to one or more content sources 175 of audio, video, graphics, text and/or other media. While broadband access 110, wireless access 120, voice access 130 and media access 140 are shown separately, one or more of these forms of access can be combined to provide multiple access services to a single client device (e.g., mobile devices 124 can receive media content via media terminal 142, data terminal 114 can be provided voice access via switching device 132, and so on).

The communications network 125 includes a plurality of network elements (NE) 150, 152, 154, 156, etc. for facilitating the broadband access 110, wireless access 120, voice access 130, media access 140 and/or the distribution of content from content sources 175. The communications network 125 can include a circuit switched or packet switched network, a voice over Internet protocol (VoIP) network, Internet protocol (IP) network, a cable network, a passive or active optical network, a 4G, 5G, or higher generation wireless access network, WIMAX network, UltraWideband network, personal area network or other wireless access network, a broadcast satellite network and/or other communications network.

In various embodiments, the access terminal 112 can include a digital subscriber line access multiplexer (DSLAM), cable modem termination system (CMTS), optical line terminal (OLT) and/or other access terminal. The data terminals 114 can include personal computers, laptop computers, netbook computers, tablets or other computing devices along with digital subscriber line (DSL) modems, data over coax service interface specification (DOCSIS) modems or other cable modems, a wireless modem such as a 4G, 5G, or higher generation modem, an optical modem and/or other access devices.

In various embodiments, the base station or access point 122 can include a 4G, 5G, or higher generation base station, an access point that operates via an 802.11 standard such as 802.11n, 802.11ac or other wireless access terminal. The mobile devices 124 can include mobile phones, e-readers, tablets, phablets, wireless modems, and/or other mobile computing devices.

In various embodiments, the switching device 132 can include a private branch exchange or central office switch, a media services gateway, VoIP gateway or other gateway device and/or other switching device. The telephony devices 134 can include traditional telephones (with or without a terminal adapter), VoIP telephones and/or other telephony devices.

In various embodiments, the media terminal 142 can include a cable head-end or other TV head-end, a satellite receiver, gateway or other media terminal 142. The display devices 144 can include televisions with or without a set top box, personal computers and/or other display devices.

In various embodiments, the content sources 175 include broadcast television and radio sources, video on demand platforms and streaming video and audio services platforms, one or more content data networks, data servers, web servers and other content servers, and/or other sources of media.

In various embodiments, the communications network 125 can include wired, optical and/or wireless links and the network elements 150, 152, 154, 156, etc. can include service switching points, signal transfer points, service control points, network gateways, media distribution hubs, servers, firewalls, routers, edge devices, switches and other network nodes for routing and controlling communications traffic over wired, optical and wireless links as part of the Internet and other public networks as well as one or more private networks, for managing subscriber access, for billing and network management and for supporting other network functions.

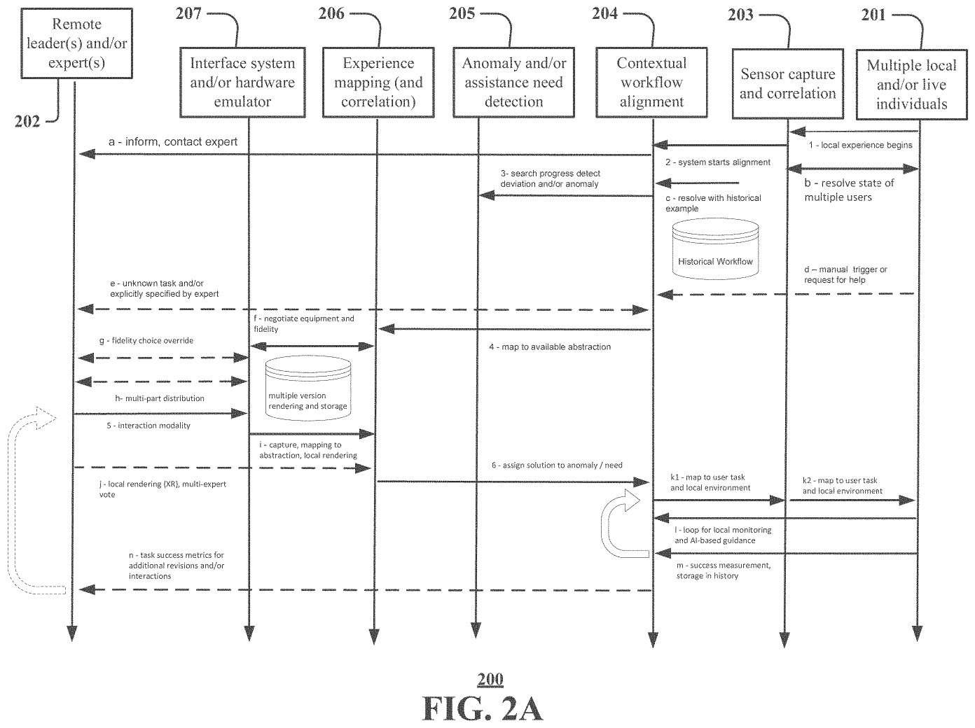

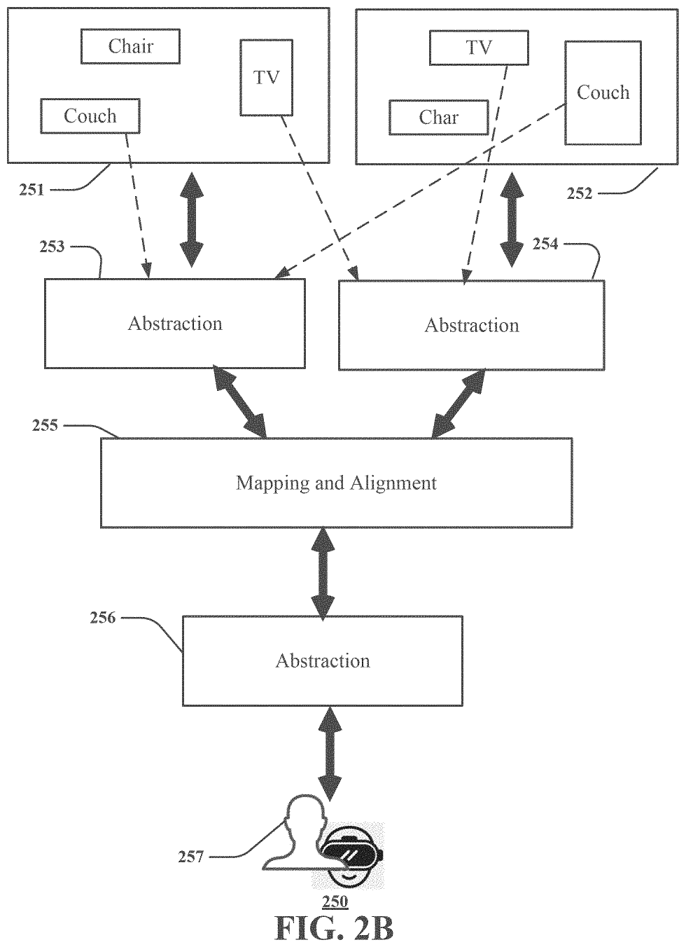

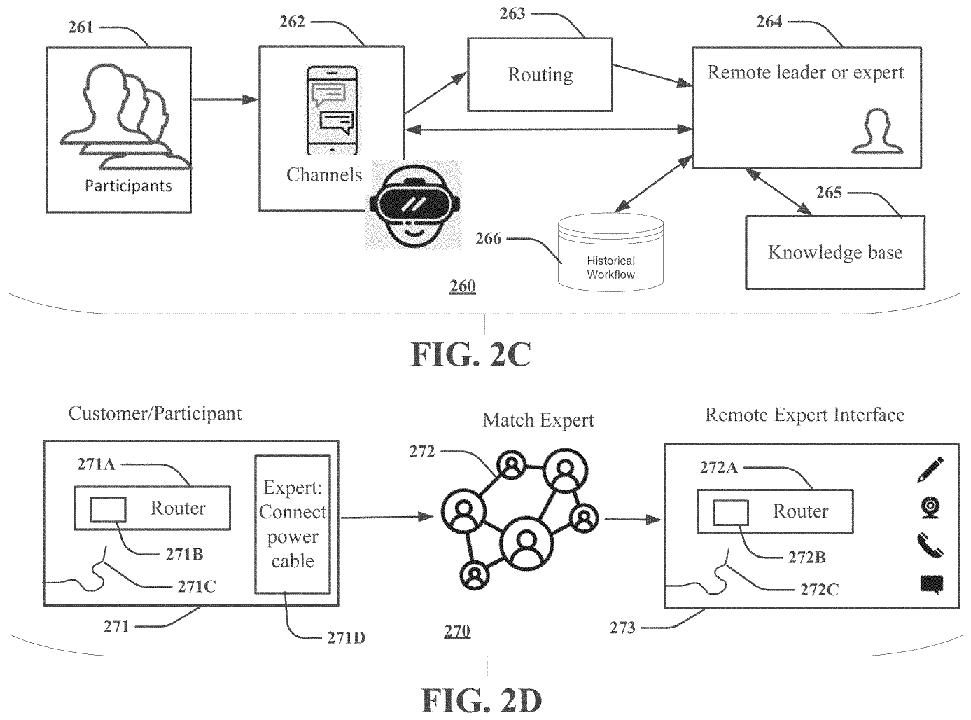

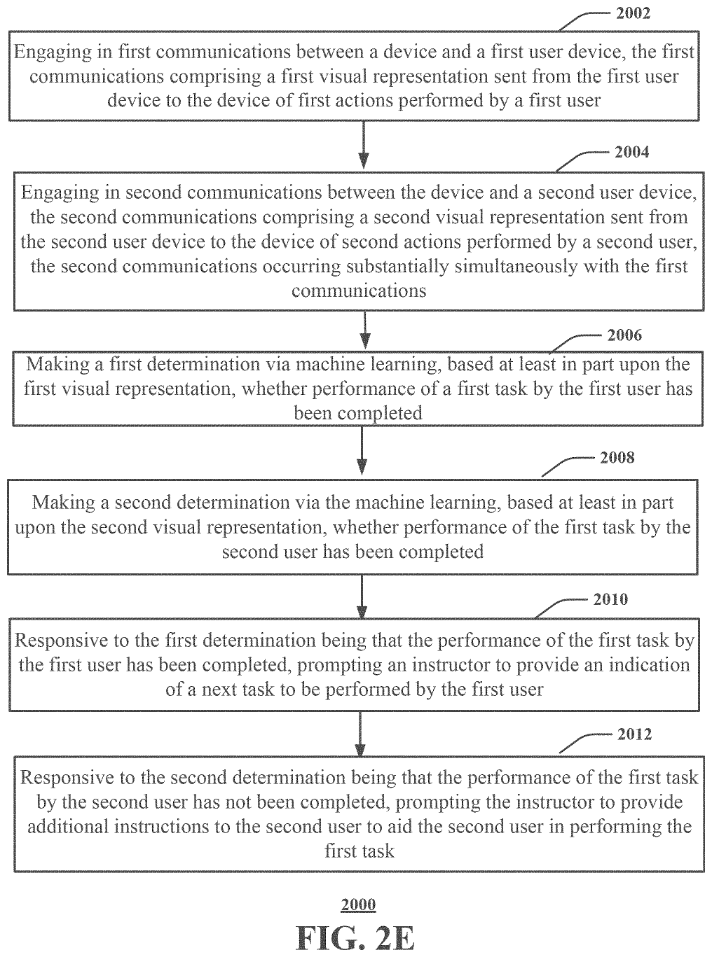

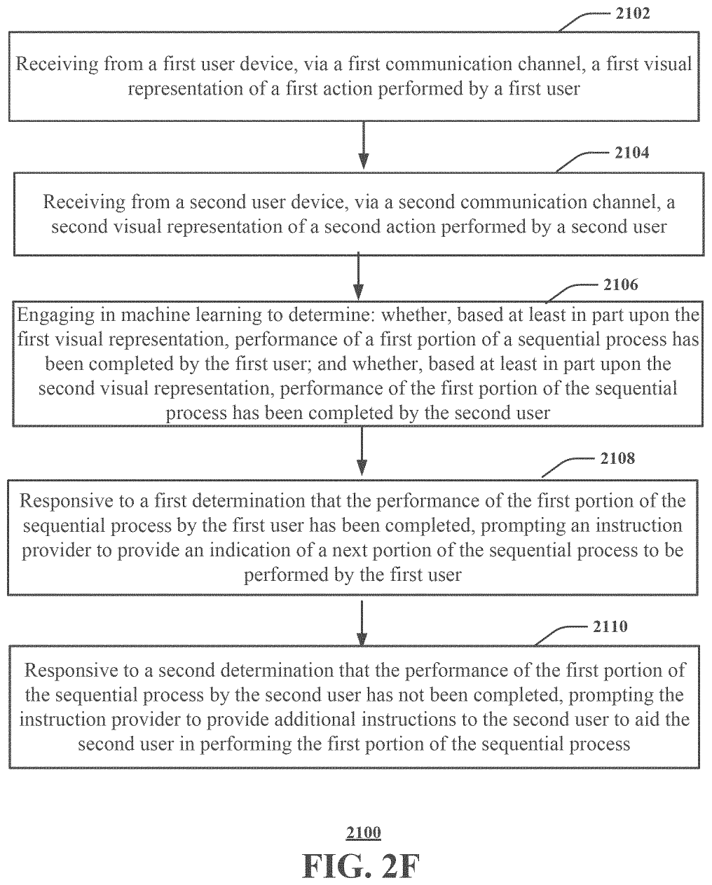

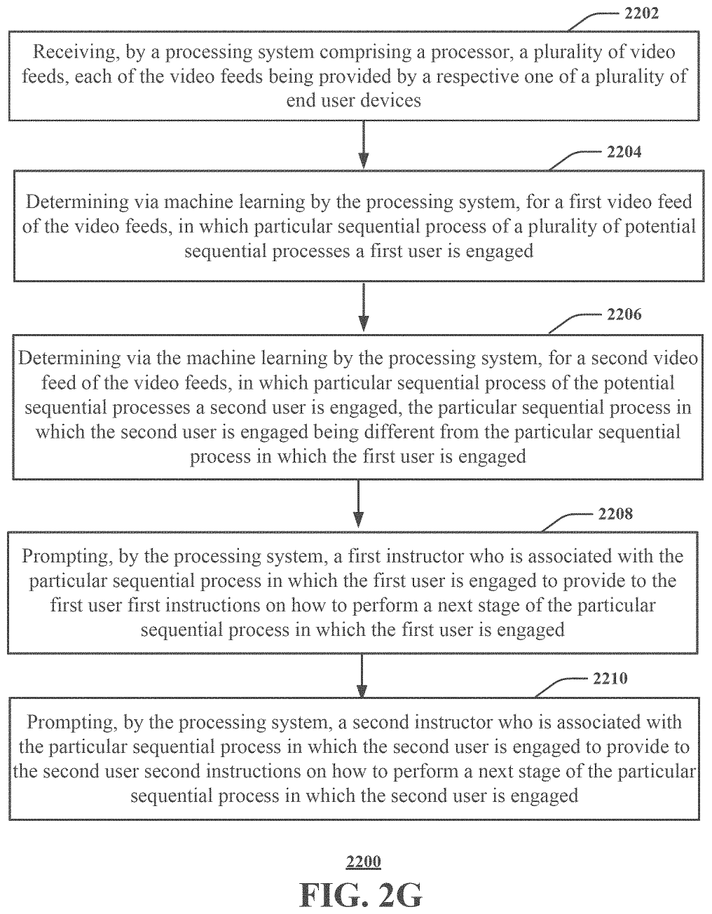

FIG. 2A is a block diagram illustrating an example, non-limiting embodiment of a system 200 (which can function, for example, fully or partially within the communication network of FIG. 1) in accordance with various aspects described herein. As seen in this FIG. 2A, system 200 can operate in the context of: a plurality of participants (see call-out number 201 showing multiple local and/or live individuals); and one or more remote leader(a) and/or expert(s) (see call-out number 202). The system 200 also includes: function(s) for sensor capture and correlation (see call-out number 203); function(s) for contextual workflow alignment (see call-out number 204); function(s) for anomaly and/or assistance need detection (see call-out number 205); function(s) for experience mapping (and correlation) (see call-out number 206); and function(s) for interface system and/or hardware emulator (see call-out number 207). In one example, a process flow associated with system 200 can be as follows: local experience begins (see arrow “1”; system starts alignment (see arrow “2”); expert is informed/contacted (see arrow “a”); resolve state of multiple users (see arrow “b”); resolve with historical example (see arrow “c”); search progress detect deviation and/or anomaly (see arrow “3”); manual trigger or request for help—optional (see arrow “d”); unknown task and/or explicitly specified by expert - optional (see arrow “e”); map to available abstraction (see arrow “4”); negotiate equipment and fidelity (see arrow “f”); fidelity choice override—optional (see arrow “g”); multi-part distribution—optional (see arrow “h”); interaction modality (see arrow “5”); capture, mapping to abstraction, local rendering (see arrow “i”); local rendering (XR), multi-expert vote (see arrow “j”); assign solution to anomaly/need (see arrow “6”); map to user task and local environment (see arrows “k1” and “k2”); loop for local monitoring and AI-based guidance (see arrow “l”); success measurement, storage in history (see arrow “m”); and/or task success metrics for additional revisions and/or interactions—optional (see arrow “n”).

Referring now to certain details of another example process flow (see also FIG. 2A): Local users begin experience—see, e.g., arrow “1” of FIG. 2A (may provide expected outcome and/or example of workflow; sensors opt-in with process for specific understanding of local user environment; optionally, as profile or requirement, user can request that experience shared only when assistance is needed (e.g. avoid ever-present camera/sensor surveillance); and/or optionally, system can be calibrated for specific workflow/objects and local user or environment). System engages in workflow alignment of task and objects—see, e.g., arrow “2” of FIG. 2A (if needed, system can resolve states of multiple local users individually; otherwise, determine average state or bounds (for expert contributions); using historical examples, attempt to align seen actions with expected actions within the overall workflow). By search/map to a specific solution by system detecting need from users—see, e.g., arrow “3” of FIG. 2A (search and discovery against known solutions as sequence to determine missing or anomalous steps; if tightly linked to workflow, using historical examples, determine deviation and typical trouble location for user; if not linked to workflow (e.g. party or social event), expert can specify specific user identity (e.g. recognition), known activities in the workflow (e.g. wedding vow, at bat), use other examples of local excitement (e.g. audio); as participant or by expert/party-planner (system can have requirements for capturing interaction with all attendees, and/or from specific angle (e.g. assembly of part X, specific members of wedding party))); optionally, manual request for help can be triggered from one or more local users (e.g. help in retail store or with specific action). Map to available expert/remote interface (discovery/map of remote environment)—see, e.g., arrow “4” of FIG. 2A (depending on expert equipment and interface, provide various levels of fidelity interaction (textual, touch, immersive, video example, audio, etc.); expert may defer or choose low fidelity if task can be automated; expert may require high fidelity for precision activity with expert interaction or user specific demonstration; optionally, expert can be multi-party, where many expert systems simultaneously receive request for help (multiple coaches)). Expert interaction (for distribution of instructions)—see, e.g., arrow “5” of FIG. 2A (explicit demonstration with expert-facing sensors; simplified vocal and/or textual command to be interpreted by the system, executed by local example; using higher fidelity display, interaction with visual components (e.g., object, markers, UX overlay) to transmit required action to local user; parallel augmented reality rendering (e.g., user's view if projected locally for expert); multi-expert scenario can vote and/or modify output of others). Propagate back to local, updating models for detected need triggers—see, e.g., arrow “6” of FIG. 2A (sent as response to local users; execute with direct guidance (e.g., expert comments) and/or system rendered assistance (e.g., move up 2 inches, visual indicator for where to go next) and/or implied guidance (e.g., using workflow/system alignment, can detect objects)). Local user response and feedback (if system detects similar error with local user workflow, can note failure and/or poor following score by the local user; local user can solicit “second opinion” for augmentation and/or alternate instruction).

FIG. 2B is a block diagram illustrating an example, non-limiting embodiment of a system 250 (which can function, for example, fully or partially within the communication network of FIG. 1) in accordance with various aspects described herein. As seen in this FIG. 2B, multiple participants can be located in respective local locations. In this example, one participant is located at home in a room 251 having a couch, a chair and a TV. Further, a second participant is located at home in a room 252 also having a different couch, a different chair and a different TV (which are arranged in a different configuration from room 251). Respective views of each of these rooms 251, 252 can be transmitted to a system (e.g., one or more servers or the like) via one or more respective cameras, webcams, or the like. Further, it is seen that the couch in room 251 and the couch in room 252 are identified by abstraction process 253. Moreover, it is seen that the TV in room 251 and the TV in room 252 are identified by abstraction process 254. In addition, a mapping and alignment process 255 is performed along with another abstraction process 256. A remote expert 257 (or the like) receives abstracted, mapped and aligned views of the different rooms 251 and 252 to facilitate the provision of guidance, instructions and/or the like by the remote expert to each of the local participants.

As described herein, various embodiments can thus provide a mechanism to simplify the challenge of remote/local task alignment for one-to-many workflow broadcasts. In various examples, one or more of the following can be provided: (a) Automatic binding of specific local items to single workflow—allows replication and/or manipulation of proxies on remote to link to meaningful/actionable items on local side; (b) Simplified remote interface (multimodal)—allow the expert to use AI (artificial intelligence) guidance for skipping some workflow steps (e.g., voice command, picture of before/after, demonstration) where the AI interprets the correct steps on both sides (remote observations, local practice); and/or Automatic evaluation from remote instructions (e.g., new demonstration) with local examples via AI guidance—validation of completion for each step (confirmation) and/or capture of the faulty execution of a step; could also provide evaluation statistics to the remote/expert for additional refinement.

FIG. 2C is a block diagram illustrating an example, non-limiting embodiment of a system 260 (which can function, for example, fully or partially within the communication network of FIG. 1) in accordance with various aspects described herein. This FIG. 2C shows an example of local tech repairs aided by a remote expert. As seen, each of a plurality of participants 261 utilizes a respective channel 262 (e.g., wireless channel facilitated via use of a respective smartphone, tablet, or the like) to communicate with a remote leader or expert 264 via routing 263 (such routing can be performed, for example, by one or more servers). The remote leader or expert 264 can be in communication with knowledge base 265 and historical workflow database 266. Such knowledge base 265 and historical workflow database 266 can be used by the remote leader or expert 264 to facilitate the provision of guidance, instructions and/or the like by the remote leader or expert 264 to each of the local participants 261.

FIG. 2D is a block diagram illustrating an example, non-limiting embodiment of a system 270 (which can function, for example, fully or partially within the communication network of FIG. 1) in accordance with various aspects described herein. This FIG. 2D also shows an example of local tech repairs aided by a remote expert. Each of a plurality of participants (one of which, customer/participant 271, is shown in this figure) uses a communication device to communicate with remote expert interface 273. The particular remote expert interface with which the customer/participant 271 communicates is determined by the match expert process 272 (which can be carried out, for example, by one or more servers). In this example, the customer/participant 271 is installing a router 271A. At the stage of the guidance shown here, the expert is directing (via text box 271D) the customer/participant 271 to connect power cable 271C to the appropriate connector 271B on router 271A. As seen, the remote expert interface 273 can include a corresponding view of router 271A, connector 271B and power cable 271C.

As described herein, various embodiments can thus provide a mechanism to facilitate the provision of guidance, instructions and/or the like by a remote leader or expert to each of a plurality of local participants. In one example, each of the local participants can first log into a remote care system or the like via explicit or implicit request. In another example, each of the local participants can be mapped to the correct routing (e.g., correct expert) based on their context and/or historical position in workflow. In another example, each of the local participants can be connected to a specific channel (for a specific expert).

Referring now to FIG. 2E, various steps of a method 2000 according to an embodiment are shown. As seen in this FIG. 2E, step 2002 comprises engaging in first communications between a device and a first user device, the first communications comprising a first visual representation sent from the first user device to the device of first actions performed by a first user. Next, step 2004 comprises engaging in second communications between the device and a second user device, the second communications comprising a second visual representation sent from the second user device to the device of second actions performed by a second user, the second communications occurring substantially simultaneously with the first communications. Next, step 2006 comprises making a first determination via machine learning, based at least in part upon the first visual representation, whether performance of a first task by the first user has been completed. In one example, machine learning detects the correlation of actions taken by the first user device and the second user device that trigger the same communication signal of completion (e.g., both the first and second user devices, upon completion of a task send a network signal and/or audible sound to acknowledge a cable is plugged into a router). In another example, a network signal, poll and/or indicator can be sent to one or more of the first and/or second devices as part of the sequence. An implicit step in the process can involve utilizing that signal to complete the process and machine learning (e.g., via automated, continual testing for both the first and second user devices) would detect that an additional (e.g., concluding or next-step) process is now available. For example, one device (e.g., the first user device) can be instructed to “handshake” another device (e.g., the device) with a network code when connected. In another example, one device (e.g., the device) can be instructed to “handshake” another device (e.g., the first user device) with a network code when connected. In another example, a background process can be executed by either the first user device or the device of first actions to execute the above “handshake” and proceed to send other operational data (e.g. network keys, power level, etc.). In one example, only when the action is correctly completed by the user can the process continue and a machine learning method can determine (e.g., through root cause analysis) which step in the process is at fault (e.g., an action of the user, a failure of the user device, a failure of the user action device, etc.). In one example, the result of this determination is utilized in step 2006. Next, step 2008 comprises making a second determination via the machine learning, based at least in part upon the second visual representation, whether performance of the first task by the second user has been completed. In one example, the machine learning of step 2006 is the same (e.g., uses the same machine learning/artificial intelligence algorithm(s)) as the machine learning of step 2008. In another example, the machine learning of step 2006 is different (e.g., uses different machine learning/artificial intelligence algorithm(s)) from the machine learning of step 2008. In another example (wherein the machine learning of step 2006 is different from the machine learning of step 2008), the different machine learning/artificial intelligence algorithm(s) for each of the steps 2006, 2008 can be based upon different users and/or based upon other different scenarios. Next, step 2010 comprises responsive to the first determination being that the performance of the first task by the first user has been completed, prompting an instructor to provide an indication of a next task to be performed by the first user. Next, step 2012 comprises responsive to the second determination being that the performance of the first task by the second user has not been completed, prompting the instructor to provide additional instructions to the second user to aid the second user in performing the first task.

While for purposes of simplicity of explanation, the respective processes are shown and described as a series of blocks in FIG. 2E, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2F, various steps of a method 2100 according to an embodiment are shown. As seen in this FIG. 2F, step 2102 comprises receiving from a first user device, via a first communication channel, a first visual representation of a first action performed by a first user. Next, step 2104 comprises receiving from a second user device, via a second communication channel, a second visual representation of a second action performed by a second user. Next, step 2106 comprises engaging in machine learning to determine: whether, based at least in part upon the first visual representation, performance of a first portion of a sequential process has been completed by the first user; and whether, based at least in part upon the second visual representation, performance of the first portion of the sequential process has been completed by the second user. In one example, a machine learning method can compare the proximity of detected objects is approximately the same (e.g. from visual representation in steps 2102 and 2104) to determine that a cable is adjacent to a router in both inputs. Next, step 2108 comprises responsive to a first determination that the performance of the first portion of the sequential process by the first user has been completed, prompting an instruction provider to provide an indication of a next portion of the sequential process to be performed by the first user. Next, step 2110 comprises responsive to a second determination that the performance of the first portion of the sequential process by the second user has not been completed, prompting the instruction provider to provide additional instructions to the second user to aid the second user in performing the first portion of the sequential process.

While for purposes of simplicity of explanation, the respective processes are shown and described as a series of blocks in FIG. 2F, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Referring now to FIG. 2G, various steps of a method 2200 according to an embodiment are shown. As seen in this FIG. 2G, step 2202 comprises receiving, by a processing system comprising a processor, a plurality of video feeds, each of the video feeds being provided by a respective one of a plurality of end user devices. Next, step 2204 comprises determining via machine learning by the processing system, for a first video feed of the video feeds, in which particular sequential process of a plurality of potential sequential processes a first user is engaged. Next, step 2206 comprises determining via the machine learning by the processing system, for a second video feed of the video feeds, in which particular sequential process of the potential sequential processes a second user is engaged, the particular sequential process in which the second user is engaged being different from the particular sequential process in which the first user is engaged. In one example, machine learning determines that a complete sequence of events (e.g., via analysis of continuously detected smaller event sequences) was executed in both of the visual representations. In one example, there is an exact visual correspondence between the two actions (e.g., turning a similarly red-colored screwdriver five times). In another example, correspondence is measured via both the action (e.g., turning a screw) and attribution of the action to a specific object (e.g., a screwdriver and a screw) over time. In both these preceding examples, complete or partial observance of the events from steps 2202 and 2204 can be determined to have a similarity that surpasses a minimum threshold and therefore is determined as completed. Next, step 2208 comprises prompting, by the processing system, a first instructor who is associated with the particular sequential process in which the first user is engaged to provide to the first user first instructions on how to perform a next stage of the particular sequential process in which the first user is engaged. Next, step 2210 comprises prompting, by the processing system, a second instructor who is associated with the particular sequential process in which the second user is engaged to provide to the second user second instructions on how to perform a next stage of the particular sequential process in which the second user is engaged.

While for purposes of simplicity of explanation, the respective processes are shown and described as a series of blocks in FIG. 2G, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described herein.

Reference will now be made to use case exploration of “Remote Event Participation” according to various embodiments. One such use case relates to tech or consumer installation and/or repair of equipment. In one aspect, directed to remote guidance for an activity, a remote expert can provide to a local novice (and/or to another expert) certain guidance. In another aspect, a mapping system can go from complex instructions (e.g., either spoken/explicit or automated form workflow from the remote participation). For instance, the system can recognize a similar issue or solution and propose some historical solutions to the local user (both from current remote assistant and from historical remote assistants). In another aspect, on local side (live), with “mapped instructions” can use local interactions for context (e.g., those devices that provided sensor input like RG (a residential gateway or router) or an augmented reality (AR) environment).

Still referring to the use case exploration of “Remote Event Participation” according to various embodiments, another such use case relates to remote coaching and assistance in sporting events (e.g., baseball, tennis). In one aspect, local sensors can be used for capturing interactions and getting remote guidance. For instance, sensors can utilize local biometrics and/or environment sensors. In another aspect, remote coaching/assistance can be expanded to new market of one-to-many coaching (e.g., PELOTON).

Still referring to the use case exploration of “Remote Event Participation” according to various embodiments, another such use case relates to birthday or wedding participation for a photographer or wedding planner. In one aspect, live interactions with parts of the event (e.g., vows, walking isle, etc.) can be carried out with a photographer or planner who is capturing event. For instance, a remote participant can provide quality assurance for each photograph (e.g., quality assurance to local photographer). In another example, a local photographer is following workflow of the wedding event, and must capture each portion. Similarly, a remote orchestrator can be guiding one or more local event planner(s) and/or assistance provider(s) to bind local execution (e.g., each person (such as local photographer) should capture with this angle, audio, and/or member of wedding party). In another example, dynamic adjustments to the workflow can come from unique instances (e.g., here the different guests, which are informed by a histogram of recognized faces).

Still referring to the use case exploration of “Remote Event Participation” according to various embodiments, another such use case relates to one salesperson broadcasting to multiple shoppers (e.g., when needing interaction with retail store staff for remote help on shopping). In one aspect, extra assistance can be provided from a VA (virtual assistant) and/or live person for consultation. In another example, one task solution can be delivered to many people.

As described herein, various embodiments can facilitate taking photographs, such as via a visual template for event. For instance, align to specific steps in “workflow”. In one example, a remote update can be utilized for better picture quality—getting assistance for best angle or specific events. In one example, a dynamic update can be provided for specific guests to be captured (photographed). For instance, specific guests can be identified from local sensor recognition and/or remote approval of the target guests. In another example, AI (artificial intelligence) can recognize idle time in the event and add other optional data additions.

As described herein, various embodiments can provide for remote shopping (e.g., feel and understanding of ripeness and available produce).

As described herein, various embodiments can provide a combination of local sensors (e.g., audio, video, etc.) that can effectively map a local environment once such that the local environment is generically represented for other remote users.

As described herein, various embodiments can provide (e.g., in the context of instruction delivery) replication of specific tasks to be repeated. In one example, AI (artificial intelligence) and/or ML (machine learning) can be used to recognize and map an action (e.g., speech, demonstration, visual) to a specific task. Such specific task could then be further mapped to one example that is reusable by many users. In one example, a mechanism that can recognize task completion can provide validation and reporting of task quality (this could be automated for simpler detection and assignment of assistance need).

As described herein, various embodiments can provide asynchronous guided assistance at scale (e.g., for thousands of users). In one example, the guided assistance can be in association with a leader-led application where guidance from one person (such as the leader) can be applied to others where there is the same or similar outcome.

As described herein, various embodiments can provide coordination of local context execution of multiple components by remote-observation of the individual processes (e.g., individual assembly processes), spotting those processes (or portions thereof) that are anomalous and/or need help and only grabbing attention then.

As described herein, various embodiments can provide a cross-modal solution. In one example, a cross-modal solution can comprise an immersive human-computer interface with real-time interaction (e.g., voice, image, demonstration, etc.). In one specific example, one or more visual and/or immersive proxies can be utilized in manipulation and representation on either side of the experience.

As described herein, various embodiments can provide immediate evaluation of a solution. In one example, this can comprise remote reply real-time feedback (because the solution can be automatically evaluated on local side) and can provide immediate “next steps” course of action to a user (such “next steps” course of action can be auto generated and/or guided).

As described herein, various embodiments can provide AI (artificial intelligence) assist from incremental concept learning by human coaching. For instance (in connection with a sporting event), a process can be generalized from multiple examples (e.g., general how to swing a racquet or baseball bat); those who may need specialization can connect to coaches (e.g., specific stances, angle, weight, etc.) and such connection to coaches can be triggered as needed (or as prompted by coach).

As described herein, various embodiments can provide systems and methods for contextual participation for remote events.

As described herein, various embodiments can apply to all desired assisted remote install, coaching, and/or remote participation events.

As described herein, various embodiments can provide for one or more of the following benefits: (1) for easier remote guidance on a predetermined workflow, assists in arbitrary matching of a local environment (e.g., placement of items, different models, alternate visualizations); (2) by allowing multimodal responses and/or suggestions from remote/expert, reduces burden on mapping to local environment; instead, utilize the AI (artificial intelligence) and/or ML (machine learning) to map and exactly indicate which item should be manipulated locally; (3) cost savings via reduction of expert dispatches for installation; can simultaneously link to one or more solutions and/or reuse previous steps; and/or (4) allows one remote/expert to simultaneously instruct multiple local users for completion of a task, where variance is automatically detected and accommodated.

As described herein, various embodiments can provide improvements for many-to-one remote review and assistance through system automation.

As described herein, various embodiments can provide support for unstructured tasks to be coordinated—for instance, determine that a local task is occurring (e.g., taking photos) and trigger the participation of remote individuals (e.g., grab a photo, pose for a photo to be integrated).

As described herein, various embodiments can provide a mechanism that recognizes idle time of local participants (e.g., they have completed specific steps in workflow already), after which the mechanism suggests other steps that have been found in similar workflows to make that idle time more productive (e.g., capturing more data, fixing previous errors, etc.).

As described herein, various embodiments can provide a mechanism that enables joint creation of a new workflow from both remote and local participants, where each can contribute some demonstrations or manipulation of the environment for better task quality and/or broader workflow completion.

As described herein, various embodiments can provide a mechanism that enables definition of dynamic placeholders (e.g., number of screws, wires, different devices to be connected) that are adapted when the local user attaches their progress to the specific workflow. In one example, the mechanism can accommodate repeated steps and validate quality of each execution.

As described herein, various embodiments can provide a mechanism that enables safety and capability enhancement with guided approval—for instance, allow automated solution to start/verify, but during escalation need approval for human, but only for specific task.

As described herein, various embodiments can provide remote review and guidance. In various examples, there can be a need for remote help for many different tasks and such need can be met by remote streaming of local image, video, and/or sensory data for assistance. In one specific example, the solution can use high-bandwidth streaming connected to opportunistic updates. In various examples, use cases can include: (a) photography and picking the correct shot—instant human feedback, which can be optimized by interactions with an AI (artificial intelligence); (b) finding the correct fruit—such as product comparison of two items (e.g., centralize the decision and defer to quality experts); and/or (c) problem diagnosis. In various examples, a platform can implement: (a) reverse “mirror” condition where many remote operators can help; (b) hospitality and theme parks can use interactions from devices to help through situation (e.g., living in place); and/or (c) allow someone remote to control your IoT (internet of things) devices (and/or other devices) remotely.

As described herein, various embodiments can provide a mechanism to simplify the challenge of remote/local task alignment for one-to-many workflow broadcasts. Automatic binding of specific local items to a single workflow can enable replication or manipulation of proxies on remote to link to meaningful/actionable items on local side.

As described herein, various embodiments can provide a simplified remote interface (e.g., multimodal) which can allow the expert to use AI (artificial intelligence) guidance for skipping some workflow steps (e.g., voice command, picture of before/after, demonstration) where the system interprets the correct steps on both sides (remote observations, local practice). In one example, automatic evaluation from remote instructions (e.g., new demonstration) with local examples via AI (artificial intelligence) can be implemented. In one example, validation of completion for each step (confirmation) and/or capture of the faulty execution of a step can be implemented. In one example, evaluation statistics can be provided to the remote/expert for additional refinement.

As described herein, various embodiments can facilitate reversing a broadcast paradigm wherein user content is sent out to one or more remote participants.

As described herein, various embodiments can facilitate the following use case example: streaming to multiple people with a raw stream and the people can edit, slice, and composite remotely instead of relying on local user.

As described herein, various embodiments can provide intelligent routing, allowing merging of remote commands into one device.

As described herein, various embodiments can modulate how data is collected and aggregated.

As described herein, various embodiments can facilitate manipulation of a live environment (e.g., IoT or other). In one example, opportunistic collection for aggregation can be provided (e.g., wherein something is analyzed to see what to further broadcast).

As described herein, various embodiments can use high-bandwidth and distribution, farming out to multiple experts so they can all contribute (e.g., expert in tactile response, expert in supply chain to prior product, etc.).

As described herein, various embodiments can utilize aspects of automation that is similar, for example, to certain conventional cloud solutions (e.g., GOOGLE PHOTO). In various embodiments, the automation can be combined with human input (e.g., for composite and live capabilities various embodiments can provide for a human to help to spot-review and/or compose).

As described herein, various embodiments can automate some (or all) of the feedback—e.g., for a particular environment or setting, various embodiments could understand that a local user did or didn't get all of the inventory (e.g., a photographer photographing all faces in a wedding).

As described herein, various embodiments can help determine how to compose a photograph for a different scene as a starter for others to use.

As described herein, various embodiments can provide for the following use case—implementing a gaze-guided concept to assist assembly (e.g., by understanding a local user's gaze the system can determine that the user wants/needs assistance (and can, for example, provide the user one or more tutorials)).

As described herein, various embodiments can provide a “smart” tool that can help to improve a local user's solution and/or execution for a given task (in one example, the local user can self-manipulate the tool to solve the problem).

As described herein, various embodiments can provide reinforcement learning that assists a local user while the local user is performing an activity. In one embodiment, one or more users repeating the same action can cause the machine learning to revise previous thresholds (e.g., from device to device communication, visual inspection and/or video event analysis) for determination of task completion specific to one or more users and/or specific to one or more workflows. In another embodiment, a reinforcement learning system can adapt to user performance by combining one or more determination steps with a single user action. This adaptation is beyond certain traditional machine learning because it was not defined by the initial remote support personnel.

As described herein, various embodiments can provide workflow guidance (e.g., instructional video, walking customer through a problem).

As described herein, various embodiments can provide an understanding of what objects are being dealt with and where a person is in a workflow.

As described herein, various embodiments can provide step-by-step guidance.

As described herein, various embodiments can provide one-to-one or many-to-one guidance.

As described herein, various embodiments can provide automated routing (e.g., assign a particular expert).

As described herein, various embodiments can provide spotting of anomalies. This can be accomplished, for example, via AI, via expert(s), via one or more visual mechanisms, and/or via one or more behavioral mechanisms.

As described herein, various embodiments can provide automatic suggestion (and/or consulted expert and/or historical) to move forward and/or to come out of an anomaly (e.g., see how others have recovered from an error).

As described herein, various embodiments can set up steps of a process without temporal dependencies (e.g., do all steps, just in a different order).

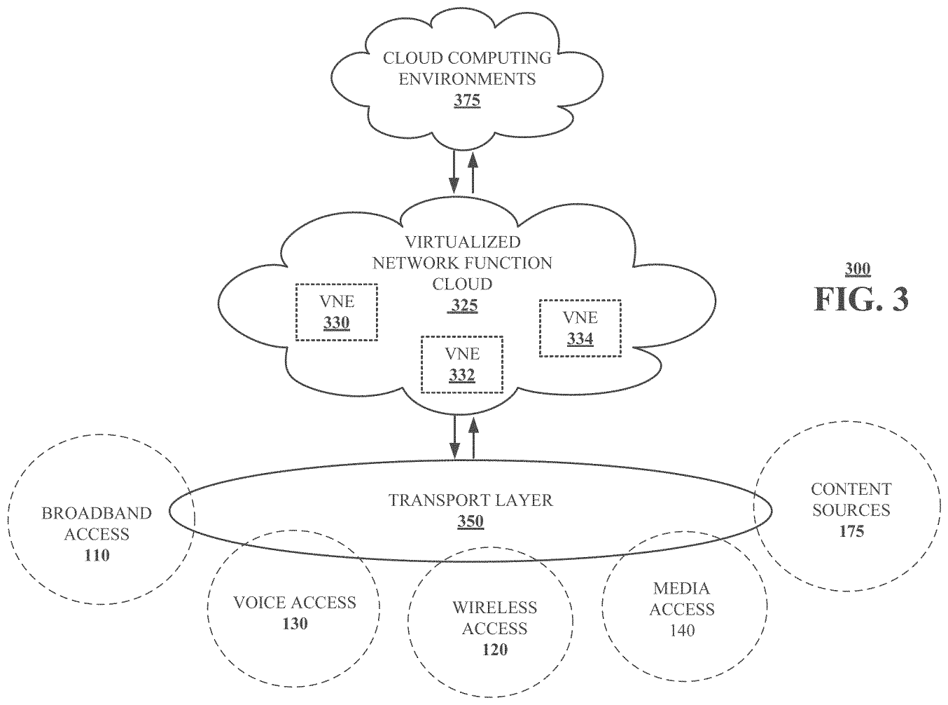

Referring now to FIG. 3, a block diagram 300 is shown illustrating an example, non-limiting embodiment of a virtualized communication network in accordance with various aspects described herein. In particular, a virtualized communication network is presented that can be used to implement some or all of the subsystems and functions of system 100, 200, 250, 260 and/or 270 presented in FIGS. 1 and 2A-2D, and some or all of method 2000, 2100 and/or 2200 presented in FIGS. 2E-2G. For example, virtualized communication network 300 can facilitate in whole or in part providing contextual participation (e.g., expert help and/or advice) for remote events.

In particular, a cloud networking architecture is shown that leverages cloud technologies and supports rapid innovation and scalability via a transport layer 350, a virtualized network function cloud 325 and/or one or more cloud computing environments 375. In various embodiments, this cloud networking architecture is an open architecture that leverages application programming interfaces (APIs); reduces complexity from services and operations; supports more nimble business models; and rapidly and seamlessly scales to meet evolving customer requirements including traffic growth, diversity of traffic types, and diversity of performance and reliability expectations.

In contrast to traditional network elements—which are typically integrated to perform a single function, the virtualized communication network employs virtual network elements (VNEs) 330, 332, 334, etc. that perform some or all of the functions of network elements 150, 152, 154, 156, etc. For example, the network architecture can provide a substrate of networking capability, often called Network Function Virtualization Infrastructure (NFVI) or simply infrastructure that is capable of being directed with software and Software Defined Networking (SDN) protocols to perform a broad variety of network functions and services. This infrastructure can include several types of substrates. The most typical type of substrate being servers that support Network Function Virtualization (NFV), followed by packet forwarding capabilities based on generic computing resources, with specialized network technologies brought to bear when general purpose processors or general purpose integrated circuit devices offered by merchants (referred to herein as merchant silicon) are not appropriate. In this case, communication services can be implemented as cloud-centric workloads.

As an example, a traditional network element 150 (shown in FIG. 1), such as an edge router can be implemented via a VNE 330 composed of NFV software modules, merchant silicon, and associated controllers. The software can be written so that increasing workload consumes incremental resources from a common resource pool, and moreover so that it's elastic: so the resources are only consumed when needed. In a similar fashion, other network elements such as other routers, switches, edge caches, and middle-boxes are instantiated from the common resource pool. Such sharing of infrastructure across a broad set of uses makes planning and growing infrastructure easier to manage.

In an embodiment, the transport layer 350 includes fiber, cable, wired and/or wireless transport elements, network elements and interfaces to provide broadband access 110, wireless access 120, voice access 130, media access 140 and/or access to content sources 175 for distribution of content to any or all of the access technologies. In particular, in some cases a network element needs to be positioned at a specific place, and this allows for less sharing of common infrastructure. Other times, the network elements have specific physical layer adapters that cannot be abstracted or virtualized, and might require special DSP code and analog front-ends (AFEs) that do not lend themselves to implementation as VNEs 330, 332 or 334. These network elements can be included in transport layer 350.

The virtualized network function cloud 325 interfaces with the transport layer 350 to provide the VNEs 330, 332, 334, etc. to provide specific NFVs. In particular, the virtualized network function cloud 325 leverages cloud operations, applications, and architectures to support networking workloads. The virtualized network elements 330, 332 and 334 can employ network function software that provides either a one-for-one mapping of traditional network element function or alternately some combination of network functions designed for cloud computing. For example, VNEs 330, 332 and 334 can include route reflectors, domain name system (DNS) servers, and dynamic host configuration protocol (DHCP) servers, system architecture evolution (SAE) and/or mobility management entity (MME) gateways, broadband network gateways, IP edge routers for IP-VPN, Ethernet and other services, load balancers, distributers and other network elements. Because these elements don't typically need to forward large amounts of traffic, their workload can be distributed across a number of servers—each of which adds a portion of the capability, and overall which creates an elastic function with higher availability than its former monolithic version. These virtual network elements 330, 332, 334, etc. can be instantiated and managed using an orchestration approach similar to those used in cloud compute services.

The cloud computing environments 375 can interface with the virtualized network function cloud 325 via APIs that expose functional capabilities of the VNEs 330, 332, 334, etc. to provide the flexible and expanded capabilities to the virtualized network function cloud 325. In particular, network workloads may have applications distributed across the virtualized network function cloud 325 and cloud computing environment 375 and in the commercial cloud, or might simply orchestrate workloads supported entirely in NFV infrastructure from these third party locations.

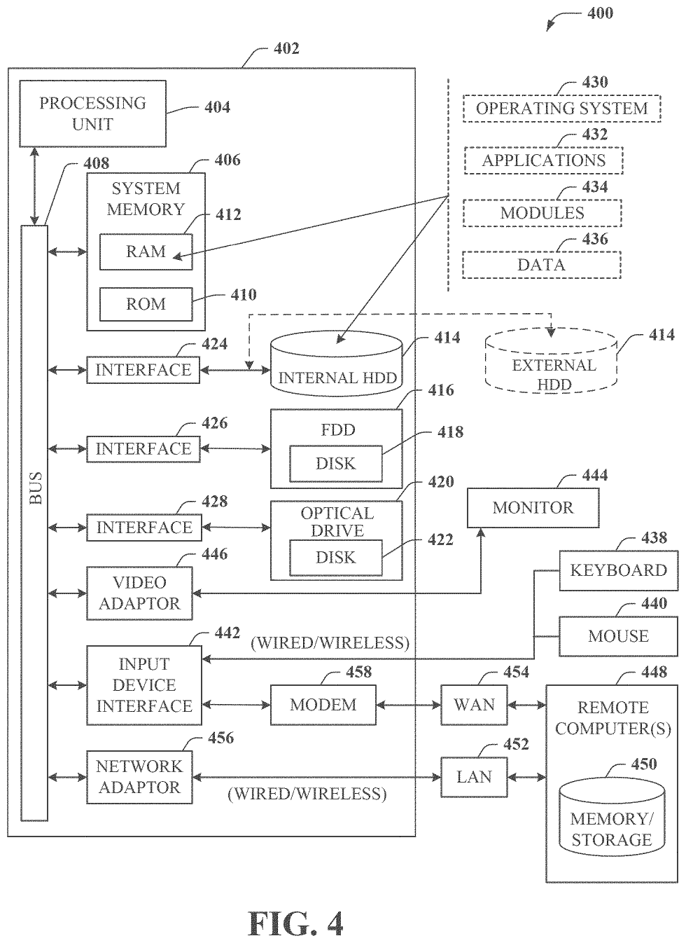

Turning now to FIG. 4, there is illustrated a block diagram of a computing environment in accordance with various aspects described herein. In order to provide additional context for various embodiments of the embodiments described herein, FIG. 4 and the following discussion are intended to provide a brief, general description of a suitable computing environment 400 in which the various embodiments of the subject disclosure can be implemented. In particular, computing environment 400 can be used in the implementation of network elements 150, 152, 154, 156, access terminal 112, base station or access point 122, switching device 132, media terminal 142, and/or VNEs 330, 332, 334, etc. Each of these devices can be implemented via computer-executable instructions that can run on one or more computers, and/or in combination with other program modules and/or as a combination of hardware and software. For example, computing environment 400 can facilitate in whole or in part providing contextual participation (e.g., expert help and/or advice) for remote events.

Generally, program modules comprise routines, programs, components, data structures, etc., that perform particular tasks or implement particular abstract data types. Moreover, those skilled in the art will appreciate that the methods can be practiced with other computer system configurations, comprising single-processor or multiprocessor computer systems, minicomputers, mainframe computers, as well as personal computers, hand-held computing devices, microprocessor-based or programmable consumer electronics, and the like, each of which can be operatively coupled to one or more associated devices.

As used herein, a processing circuit includes one or more processors as well as other application specific circuits such as an application specific integrated circuit, digital logic circuit, state machine, programmable gate array or other circuit that processes input signals or data and that produces output signals or data in response thereto. It should be noted that while any functions and features described herein in association with the operation of a processor could likewise be performed by a processing circuit.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically comprise a variety of media, which can comprise computer-readable storage media and/or communications media, which two terms are used herein differently from one another as follows. Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data or unstructured data.

Computer-readable storage media can comprise, but are not limited to, random access memory (RAM), read only memory (ROM), electrically erasable programmable read only memory (EEPROM),flash memory or other memory technology, compact disk read only memory (CD-ROM), digital versatile disk (DVD) or other optical disk storage, magnetic cassettes, magnetic tape, magnetic disk storage or other magnetic storage devices or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

With reference again to FIG. 4, the example environment can comprise a computer 402, the computer 402 comprising a processing unit 404, a system memory 406 and a system bus 408. The system bus 408 couples system components including, but not limited to, the system memory 406 to the processing unit 404. The processing unit 404 can be any of various commercially available processors. Dual microprocessors and other multiprocessor architectures can also be employed as the processing unit 404.

The system bus 408 can be any of several types of bus structure that can further interconnect to a memory bus (with or without a memory controller), a peripheral bus, and a local bus using any of a variety of commercially available bus architectures. The system memory 406 comprises ROM 410 and RAM 412. A basic input/output system (BIOS) can be stored in a non-volatile memory such as ROM, erasable programmable read only memory (EPROM), EEPROM, which BIOS contains the basic routines that help to transfer information between elements within the computer 402, such as during startup. The RAM 412 can also comprise a high-speed RAM such as static RAM for caching data.

The computer 402 further comprises an internal hard disk drive (HDD) 414 (e.g., EIDE, SATA), which internal HDD 414 can also be configured for external use in a suitable chassis (not shown), a magnetic floppy disk drive (FDD) 416, (e.g., to read from or write to a removable diskette 418) and an optical disk drive 420, (e.g., reading a CD-ROM disk 422 or, to read from or write to other high capacity optical media such as the DVD). The HDD 414, magnetic FDD 416 and optical disk drive 420 can be connected to the system bus 408 by a hard disk drive interface 424, a magnetic disk drive interface 426 and an optical drive interface 428, respectively. The hard disk drive interface 424 for external drive implementations comprises at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 402, the drives and storage media accommodate the storage of any data in a suitable digital format. Although the description of computer-readable storage media above refers to a hard disk drive (HDD), a removable magnetic diskette, and a removable optical media such as a CD or DVD, it should be appreciated by those skilled in the art that other types of storage media which are readable by a computer, such as zip drives, magnetic cassettes, flash memory cards, cartridges, and the like, can also be used in the example operating environment, and further, that any such storage media can contain computer-executable instructions for performing the methods described herein.

A number of program modules can be stored in the drives and RAM 412, comprising an operating system 430, one or more application programs 432, other program modules 434 and program data 436. All or portions of the operating system, applications, modules, and/or data can also be cached in the RAM 412. The systems and methods described herein can be implemented utilizing various commercially available operating systems or combinations of operating systems.

A user can enter commands and information into the computer 402 through one or more wired/wireless input devices, e.g., a keyboard 438 and a pointing device, such as a mouse 440. Other input devices (not shown) can comprise a microphone, an infrared (IR) remote control, a joystick, a game pad, a stylus pen, touch screen or the like. These and other input devices are often connected to the processing unit 404 through an input device interface 442 that can be coupled to the system bus 408, but can be connected by other interfaces, such as a parallel port, an IEEE 1394 serial port, a game port, a universal serial bus (USB) port, an IR interface, etc.

A monitor 444 or other type of display device can be also connected to the system bus 408 via an interface, such as a video adapter 446. It will also be appreciated that in alternative embodiments, a monitor 444 can also be any display device (e.g., another computer having a display, a smart phone, a tablet computer, etc.) for receiving display information associated with computer 402 via any communication means, including via the Internet and cloud-based networks. In addition to the monitor 444, a computer typically comprises other peripheral output devices (not shown), such as speakers, printers, etc.

The computer 402 can operate in a networked environment using logical connections via wired and/or wireless communications to one or more remote computers, such as a remote computer(s) 448. The remote computer(s) 448 can be a workstation, a server computer, a router, a personal computer, portable computer, microprocessor-based entertainment appliance, a peer device or other common network node, and typically comprises many or all of the elements described relative to the computer 402, although, for purposes of brevity, only a remote memory/storage device 450 is illustrated. The logical connections depicted comprise wired/wireless connectivity to a local area network (LAN) 452 and/or larger networks, e.g., a wide area network (WAN) 454. Such LAN and WAN networking environments are commonplace in offices and companies, and facilitate enterprise-wide computer networks, such as intranets, all of which can connect to a global communications network, e.g., the Internet.

When used in a LAN networking environment, the computer 402 can be connected to the LAN 452 through a wired and/or wireless communication network interface or adapter 456. The adapter 456 can facilitate wired or wireless communication to the LAN 452, which can also comprise a wireless AP disposed thereon for communicating with the adapter 456.

When used in a WAN networking environment, the computer 402 can comprise a modem 458 or can be connected to a communications server on the WAN 454 or has other means for establishing communications over the WAN 454, such as by way of the Internet. The modem 458, which can be internal or external and a wired or wireless device, can be connected to the system bus 408 via the input device interface 442. In a networked environment, program modules depicted relative to the computer 402 or portions thereof, can be stored in the remote memory/storage device 450. It will be appreciated that the network connections shown are example and other means of establishing a communications link between the computers can be used.

The computer 402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This can comprise Wireless Fidelity (Wi-Fi) and BLUETOOTH® wireless technologies. Thus, the communication can be a predefined structure as with a conventional network or simply an ad hoc communication between at least two devices.

Wi-Fi can allow connection to the Internet from a couch at home, a bed in a hotel room or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, n, ac, ag, etc.) to provide secure, reliable, fast wireless connectivity. A Wi-Fi network can be used to connect computers to each other, to the Internet, and to wired networks (which can use IEEE 802.3 or Ethernet). Wi-Fi networks operate in the unlicensed 2.4 and 5 GHz radio bands for example or with products that contain both bands (dual band), so the networks can provide real-world performance similar to the basic 10BaseT wired Ethernet networks used in many offices.

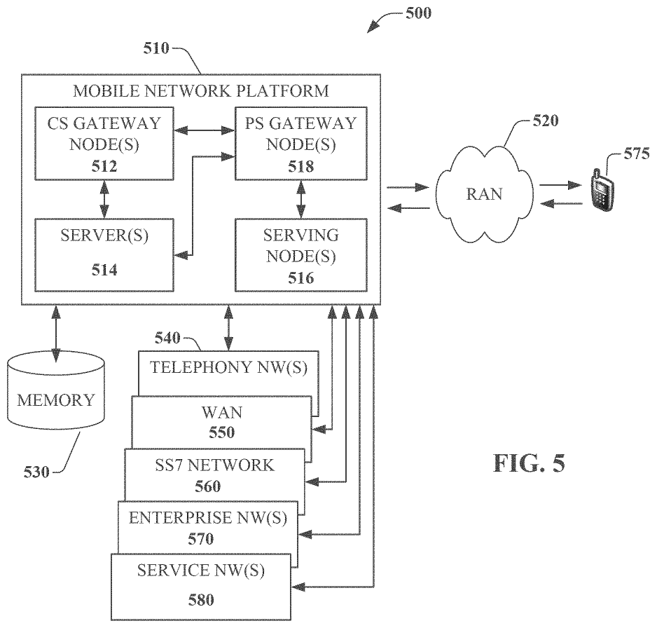

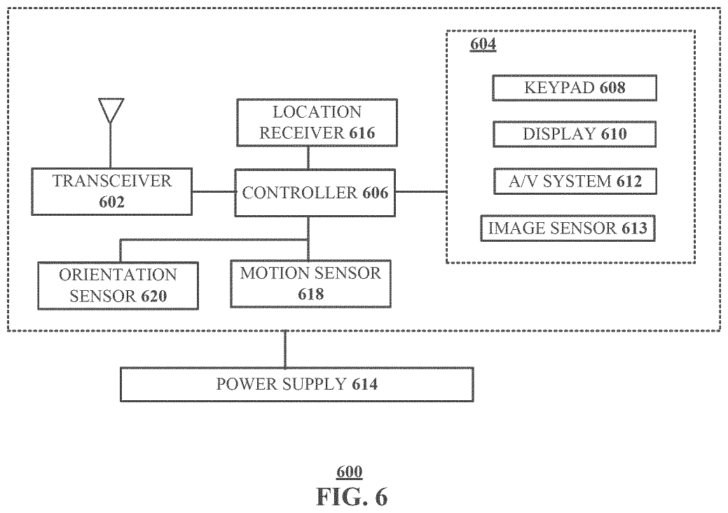

Turning now to FIG. 5, an embodiment 500 of a mobile network platform 510 is shown that is an example of network elements 150, 152, 154, 156, and/or VNEs 330, 332, 334, etc. For example, platform 510 can facilitate in whole or in part providing contextual participation (e.g., expert help and/or advice) for remote events. In one or more embodiments, the mobile network platform 510 can generate and receive signals transmitted and received by base stations or access points such as base station or access point 122. Generally, mobile network platform 510 can comprise components, e.g., nodes, gateways, interfaces, servers, or disparate platforms, that facilitate both packet-switched (PS) (e.g., internet protocol (IP), frame relay, asynchronous transfer mode (ATM)) and circuit-switched (CS) traffic (e.g., voice and data), as well as control generation for networked wireless telecommunication. As a non-limiting example, mobile network platform 510 can be included in telecommunications carrier networks, and can be considered carrier-side components as discussed elsewhere herein. Mobile network platform 510 comprises CS gateway node(s) 512 which can interface CS traffic received from legacy networks like telephony network(s) 540 (e.g., public switched telephone network (PSTN), or public land mobile network (PLMN)) or a signaling system #7 (SS7) network 560. CS gateway node(s) 512 can authorize and authenticate traffic (e.g., voice) arising from such networks. Additionally, CS gateway node(s) 512 can access mobility, or roaming, data generated through SS7 network 560; for instance, mobility data stored in a visited location register (VLR), which can reside in memory 530. Moreover, CS gateway node(s) 512 interfaces CS-based traffic and signaling and PS gateway node(s) 518. As an example, in a 3GPP UMTS network, CS gateway node(s) 512 can be realized at least in part in gateway GPRS support node(s) (GGSN). It should be appreciated that functionality and specific operation of CS gateway node(s) 512, PS gateway node(s) 518, and serving node(s) 516, is provided and dictated by radio technology(ies) utilized by mobile network platform 510 for telecommunication over a radio access network 520 with other devices, such as a radiotelephone 575.

In addition to receiving and processing CS-switched traffic and signaling, PS gateway node(s) 518 can authorize and authenticate PS-based data sessions with served mobile devices. Data sessions can comprise traffic, or content(s), exchanged with networks external to the mobile network platform 510, like wide area network(s) (WANs) 550, enterprise network(s) 570, and service network(s) 580, which can be embodied in local area network(s) (LANs), can also be interfaced with mobile network platform 510 through PS gateway node(s) 518. It is to be noted that WANs 550 and enterprise network(s) 570 can embody, at least in part, a service network(s) like IP multimedia subsystem (IMS). Based on radio technology layer(s) available in technology resource(s) or radio access network 520, PS gateway node(s) 518 can generate packet data protocol contexts when a data session is established; other data structures that facilitate routing of packetized data also can be generated. To that end, in an aspect, PS gateway node(s) 518 can comprise a tunnel interface (e.g., tunnel termination gateway (TTG) in 3GPP UMTS network(s) (not shown)) which can facilitate packetized communication with disparate wireless network(s), such as Wi-Fi networks.

In embodiment 500, mobile network platform 510 also comprises serving node(s) 516 that, based upon available radio technology layer(s) within technology resource(s) in the radio access network 520, convey the various packetized flows of data streams received through PS gateway node(s) 518. It is to be noted that for technology resource(s) that rely primarily on CS communication, server node(s) can deliver traffic without reliance on PS gateway node(s) 518; for example, server node(s) can embody at least in part a mobile switching center. As an example, in a 3GPP UMTS network, serving node(s) 516 can be embodied in serving GPRS support node(s) (SGSN).

For radio technologies that exploit packetized communication, server(s) 514 in mobile network platform 510 can execute numerous applications that can generate multiple disparate packetized data streams or flows, and manage (e.g., schedule, queue, format . . . ) such flows. Such application(s) can comprise add-on features to standard services (for example, provisioning, billing, customer support . . . ) provided by mobile network platform 510. Data streams (e.g., content(s) that are part of a voice call or data session) can be conveyed to PS gateway node(s) 518 for authorization/authentication and initiation of a data session, and to serving node(s) 516 for communication thereafter. In addition to application server, server(s) 514 can comprise utility server(s), a utility server can comprise a provisioning server, an operations and maintenance server, a security server that can implement at least in part a certificate authority and firewalls as well as other security mechanisms, and the like. In an aspect, security server(s) secure communication served through mobile network platform 510 to ensure network's operation and data integrity in addition to authorization and authentication procedures that CS gateway node(s) 512 and PS gateway node(s) 518 can enact. Moreover, provisioning server(s) can provision services from external network(s) like networks operated by a disparate service provider; for instance, WAN 550 or Global Positioning System (GPS) network(s) (not shown). Provisioning server(s) can also provision coverage through networks associated to mobile network platform 510 (e.g., deployed and operated by the same service provider), such as the distributed antennas networks shown in FIG. 1(s) that enhance wireless service coverage by providing more network coverage.

It is to be noted that server(s) 514 can comprise one or more processors configured to confer at least in part the functionality of mobile network platform 510. To that end, the one or more processor can execute code instructions stored in memory 530, for example. It is should be appreciated that server(s) 514 can comprise a content manager, which operates in substantially the same manner as described hereinbefore.

In example embodiment 500, memory 530 can store information related to operation of mobile network platform 510. Other operational information can comprise provisioning information of mobile devices served through mobile network platform 510, subscriber databases; application intelligence, pricing schemes, e.g., promotional rates, flat-rate programs, couponing campaigns; technical specification(s) consistent with telecommunication protocols for operation of disparate radio, or wireless, technology layers; and so forth. Memory 530 can also store information from at least one of telephony network(s) 540, WAN 550, SS7 network 560, or enterprise network(s) 570. In an aspect, memory 530 can be, for example, accessed as part of a data store component or as a remotely connected memory store.

In order to provide a context for the various aspects of the disclosed subject matter, FIG. 5, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that perform particular tasks and/or implement particular abstract data types.

Turning now to FIG. 6, an illustrative embodiment of a communication device 600 is shown. The communication device 600 can serve as an illustrative embodiment of devices such as data terminals 114, mobile devices 124, vehicle 126, display devices 144 or other client devices for communication via either communications network 125. For example, computing device 600 can facilitate in whole or in part providing contextual participation (e.g., expert help and/or advice) for remote events.

The communication device 600 can comprise a wireline and/or wireless transceiver 602 (herein transceiver 602), a user interface (UI) 604, a power supply 614, a location receiver 616, a motion sensor 618, an orientation sensor 620, and a controller 606 for managing operations thereof. The transceiver 602 can support short-range or long-range wireless access technologies such as Bluetooth®, ZigBee®, WiFi, DECT, or cellular communication technologies, just to mention a few (Bluetooth® and ZigBee® are trademarks registered by the Bluetooth® Special Interest Group and the ZigBee® Alliance, respectively). Cellular technologies can include, for example, CDMA-1X, UMTS/HSDPA, GSM/GPRS, TDMA/EDGE, EV/DO, WiMAX, SDR, LTE, as well as other next generation wireless communication technologies as they arise. The transceiver 602 can also be adapted to support circuit-switched wireline access technologies (such as PSTN), packet-switched wireline access technologies (such as TCP/IP, VoIP, etc.), and combinations thereof.

The UI 604 can include a depressible or touch-sensitive keypad 608 with a navigation mechanism such as a roller ball, a joystick, a mouse, or a navigation disk for manipulating operations of the communication device 600. The keypad 608 can be an integral part of a housing assembly of the communication device 600 or an independent device operably coupled thereto by a tethered wireline interface (such as a USB cable) or a wireless interface supporting for example Bluetooth®. The keypad 608 can represent a numeric keypad commonly used by phones, and/or a QWERTY keypad with alphanumeric keys. The UI 604 can further include a display 610 such as monochrome or color LCD (Liquid Crystal Display), OLED (Organic Light Emitting Diode) or other suitable display technology for conveying images to an end user of the communication device 600. In an embodiment where the display 610 is touch-sensitive, a portion or all of the keypad 608 can be presented by way of the display 610 with navigation features.

The display 610 can use touch screen technology to also serve as a user interface for detecting user input. As a touch screen display, the communication device 600 can be adapted to present a user interface having graphical user interface (GUI) elements that can be selected by a user with a touch of a finger. The display 610 can be equipped with capacitive, resistive or other forms of sensing technology to detect how much surface area of a user's finger has been placed on a portion of the touch screen display. This sensing information can be used to control the manipulation of the GUI elements or other functions of the user interface. The display 610 can be an integral part of the housing assembly of the communication device 600 or an independent device communicatively coupled thereto by a tethered wireline interface (such as a cable) or a wireless interface.

The UI 604 can also include an audio system 612 that utilizes audio technology for conveying low volume audio (such as audio heard in proximity of a human ear) and high volume audio (such as speakerphone for hands free operation). The audio system 612 can further include a microphone for receiving audible signals of an end user. The audio system 612 can also be used for voice recognition applications. The UI 604 can further include an image sensor 613 such as a charged coupled device (CCD) camera for capturing still or moving images.

The power supply 614 can utilize common power management technologies such as replaceable and rechargeable batteries, supply regulation technologies, and/or charging system technologies for supplying energy to the components of the communication device 600 to facilitate long-range or short-range portable communications. Alternatively, or in combination, the charging system can utilize external power sources such as DC power supplied over a physical interface such as a USB port or other suitable tethering technologies.

The location receiver 616 can utilize location technology such as a global positioning system (GPS) receiver capable of assisted GPS for identifying a location of the communication device 600 based on signals generated by a constellation of GPS satellites, which can be used for facilitating location services such as navigation. The motion sensor 618 can utilize motion sensing technology such as an accelerometer, a gyroscope, or other suitable motion sensing technology to detect motion of the communication device 600 in three-dimensional space. The orientation sensor 620 can utilize orientation sensing technology such as a magnetometer to detect the orientation of the communication device 600 (north, south, west, and east, as well as combined orientations in degrees, minutes, or other suitable orientation metrics).

The communication device 600 can use the transceiver 602 to also determine a proximity to a cellular, WiFi, Bluetooth®, or other wireless access points by sensing techniques such as utilizing a received signal strength indicator (RSSI) and/or signal time of arrival (TOA) or time of flight (TOF) measurements. The controller 606 can utilize computing technologies such as a microprocessor, a digital signal processor (DSP), programmable gate arrays, application specific integrated circuits, and/or a video processor with associated storage memory such as Flash, ROM, RAM, SRAM, DRAM or other storage technologies for executing computer instructions, controlling, and processing data supplied by the aforementioned components of the communication device 600.

Other components not shown in FIG. 6 can be used in one or more embodiments of the subject disclosure. For instance, the communication device 600 can include a slot for adding or removing an identity module such as a Subscriber Identity Module (SIM) card or Universal Integrated Circuit Card (UICC). SIM or UICC cards can be used for identifying subscriber services, executing programs, storing subscriber data, and so on.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It will be appreciated that the memory components described herein can be either volatile memory or nonvolatile memory, or can comprise both volatile and nonvolatile memory, by way of illustration, and not limitation, volatile memory, non-volatile memory, disk storage, and memory storage. Further, nonvolatile memory can be included in read only memory (ROM), programmable ROM (PROM), electrically programmable ROM (EPROM), electrically erasable ROM (EEPROM), or flash memory. Volatile memory can comprise random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

Moreover, it will be noted that the disclosed subject matter can be practiced with other computer system configurations, comprising single-processor or multiprocessor computer systems, mini-computing devices, mainframe computers, as well as personal computers, hand-held computing devices (e.g., PDA, phone, smartphone, watch, tablet computers, netbook computers, etc.), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

In one or more embodiments, information regarding use of services can be generated including services being accessed, media consumption history, user preferences, and so forth. This information can be obtained by various methods including user input, detecting types of communications (e.g., video content vs. audio content), analysis of content streams, sampling, and so forth. The generating, obtaining and/or monitoring of this information can be responsive to an authorization provided by the user. In one or more embodiments, an analysis of data can be subject to authorization from user(s) associated with the data, such as an opt-in, an opt-out, acknowledgement requirements, notifications, selective authorization based on types of data, and so forth.

Some of the embodiments described herein can also employ artificial intelligence (AI) to facilitate automating one or more features described herein. The embodiments (e.g., in connection with automatically providing contextual participation (e.g., expert help and/or advice) for remote events) can employ various AI-based schemes for carrying out various embodiments thereof. Moreover, the classifier can be employed to determine a ranking or priority of each contextual element for remote events. A classifier is a function that maps an input attribute vector, x=(x1, x2, x3, x4, . . . , xn), to a confidence that the input belongs to a class, that is, f(x)=confidence (class). Such classification can employ a probabilistic and/or statistical-based analysis (e.g., factoring into the analysis utilities and costs) to determine or infer an action that a user desires to be automatically performed. A support vector machine (SVM) is an example of a classifier that can be employed. The SVM operates by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches comprise, e.g., naïve Bayes, Bayesian networks, decision trees, neural networks, fuzzy logic models, and probabilistic classification models providing different patterns of independence can be employed. Classification as used herein also is inclusive of statistical regression that is utilized to develop models of priority.

As will be readily appreciated, one or more of the embodiments can employ classifiers that are explicitly trained (e.g., via a generic training data) as well as implicitly trained (e.g., via observing UE behavior, operator preferences, historical information, receiving extrinsic information). For example, SVMs can be configured via a learning or training phase within a classifier constructor and feature selection module. Thus, the classifier(s) can be used to automatically learn and perform a number of functions, including but not limited to determining according to predetermined criteria contextual elements for remote events, etc.

As used in some contexts in this application, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or computer-readable storage/communications media. For example, computer readable storage media can include, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

In addition, the words “example” and “exemplary” are used herein to mean serving as an instance or illustration. Any embodiment or design described herein as “example” or “exemplary” is not necessarily to be construed as preferred or advantageous over other embodiments or designs. Rather, use of the word example or exemplary is intended to present concepts in a concrete fashion. As used in this application, the term “or” is intended to mean an inclusive “or” rather than an exclusive “or”. That is, unless specified otherwise or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

Moreover, terms such as “user equipment,” “mobile station,” “mobile,” subscriber station,” “access terminal,” “terminal,” “handset,” “mobile device” (and/or terms representing similar terminology) can refer to a wireless device utilized by a subscriber or user of a wireless communication service to receive or convey data, control, voice, video, sound, gaming or substantially any data-stream or signaling-stream. The foregoing terms are utilized interchangeably herein and with reference to the related drawings.

Furthermore, the terms “user,” “subscriber,” “customer,” “consumer” and the like are employed interchangeably throughout, unless context warrants particular distinctions among the terms. It should be appreciated that such terms can refer to human entities or automated components supported through artificial intelligence (e.g., a capacity to make inference based, at least, on complex mathematical formalisms), which can provide simulated vision, sound recognition and so forth.

As employed herein, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit (ASIC), a digital signal processor (DSP), a field programmable gate array (FPGA), a programmable logic controller (PLC), a complex programmable logic device (CPLD), a discrete gate or transistor logic, discrete hardware components or any combination thereof designed to perform the functions described herein. Processors can exploit nano-scale architectures such as, but not limited to, molecular and quantum-dot based transistors, switches and gates, in order to optimize space usage or enhance performance of user equipment. A processor can also be implemented as a combination of computing processing units.

As used herein, terms such as “data storage,” data storage,” “database,” and substantially any other information storage component relevant to operation and functionality of a component, refer to “memory components,” or entities embodied in a “memory” or components comprising the memory. It will be appreciated that the memory components or computer-readable storage media, described herein can be either volatile memory or nonvolatile memory or can include both volatile and nonvolatile memory.

What has been described above includes mere examples of various embodiments. It is, of course, not possible to describe every conceivable combination of components or methodologies for purposes of describing these examples, but one of ordinary skill in the art can recognize that many further combinations and permutations of the present embodiments are possible. Accordingly, the embodiments disclosed and/or claimed herein are intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

In addition, a flow diagram may include a “start” and/or “continue” indication. The “start” and “continue” indications reflect that the steps presented can optionally be incorporated in or otherwise used in conjunction with other routines. In this context, “start” indicates the beginning of the first step presented and may be preceded by other activities not specifically shown. Further, the “continue” indication reflects that the steps presented may be performed multiple times and/or may be succeeded by other activities not specifically shown. Further, while a flow diagram indicates a particular ordering of steps, other orderings are likewise possible provided that the principles of causality are maintained.

As may also be used herein, the term(s) “operably coupled to”, “coupled to”, and/or “coupling” includes direct coupling between items and/or indirect coupling between items via one or more intervening items. Such items and intervening items include, but are not limited to, junctions, communication paths, components, circuit elements, circuits, functional blocks, and/or devices. As an example of indirect coupling, a signal conveyed from a first item to a second item may be modified by one or more intervening items by modifying the form, nature or format of information in a signal, while one or more elements of the information in the signal are nevertheless conveyed in a manner than can be recognized by the second item. In a further example of indirect coupling, an action in a first item can cause a reaction on the second item, as a result of actions and/or reactions in one or more intervening items.

Although specific embodiments have been illustrated and described herein, it should be appreciated that any arrangement which achieves the same or similar purpose may be substituted for the embodiments described or shown by the subject disclosure. The subject disclosure is intended to cover any and all adaptations or variations of various embodiments. Combinations of the above embodiments, and other embodiments not specifically described herein, can be used in the subject disclosure. For instance, one or more features from one or more embodiments can be combined with one or more features of one or more other embodiments. In one or more embodiments, features that are positively recited can also be negatively recited and excluded from the embodiment with or without replacement by another structural and/or functional feature. The steps or functions described with respect to the embodiments of the subject disclosure can be performed in any order. The steps or functions described with respect to the embodiments of the subject disclosure can be performed alone or in combination with other steps or functions of the subject disclosure, as well as from other embodiments or from other steps that have not been described in the subject disclosure. Further, more than or less than all of the features described with respect to an embodiment can also be utilized.

What is claimed is:

1. A device comprising:
a processing system including a processor; and
a memory that stores executable instructions that, when executed by the processing system, facilitate performance of operations, the operations comprising:
engaging in first communications between the device and a first user device, the first communications comprising a first visual representation sent from the first user device to the device of first actions performed by a first user;
engaging in second communications between the device and a second user device, the second communications comprising a second visual representation sent from the second user device to the device of second actions performed by a second user, the second communications occurring substantially simultaneously with the first communications;
making a first determination via machine learning, based at least in part upon the first visual representation, whether performance of a first task by the first user has been completed;
making a second determination via the machine learning, based at least in part upon the second visual representation, whether performance of the first task by the second user has been completed;
responsive to the first determination being that the performance of the first task by the first user has been completed, prompting an instructor to provide an indication of a next task to be performed by the first user; and
responsive to the second determination being that the performance of the first task by the second user has not been completed, prompting the instructor to provide additional instructions to the second user to aid the second user in performing the first task.

2. The device of claim 1, wherein the operations further comprise sending to the first user device via the first communications the indication of the next task to be performed by the first user, the indication of the next task to be performed by the first user comprising instructions as to how to perform the next task.

3. The device of claim 1, wherein the operations further comprise sending to the second user device via the second communications the additional instructions, the additional instructions comprising more detailed instructions, relative to any instructions that had previously been provided, as to how to perform the first task.

4. The device of claim 3, wherein the second communications further comprise an additional visual representation sent from the second user device to the device of additional actions performed by the second user, the additional actions being performed by the second user in response to the additional instructions that had been sent to the second user device.

5. The device of claim 4, wherein the additional visual representation comprises an image, a plurality of images, a video, or any combination thereof.

6. The device of claim 5, wherein the operations further comprise:
making a third determination via the machine learning, based at least in part upon the additional visual representation, whether the performance of the first task by the second user has been completed;
responsive to the third determination being that the performance of the first task by the second user has been completed, prompting the instructor to provide the indication of the next task to be performed by the second user.

7. The device of claim 1, wherein each of the first communications and the second communications is carried out via the Internet.

8. The device of claim 1, wherein:
the first user device comprises a first desktop computer, a first laptop computer, a first tablet, a first smartphone, or any first combination thereof; and
the second user device comprises a second desktop computer, a second laptop computer, a second tablet, a second smartphone, or any second combination thereof.

9. The device of claim 1, wherein:
the first visual representation comprises a first image, a first plurality of images, a first video, or any first combination thereof; and
the second visual representation comprises a second image, a second plurality of images, a second video, or any second combination thereof.

10. The device of claim 1, wherein the first task and the next task are part of a sequential plurality of tasks to be performed.

11. The device of claim 1, wherein the making of the first determination via the machine learning is further based upon an abstraction of a performance of the first task, the abstraction of the performance of the first task being based upon a plurality of prior performances of the first task by each respective one of a plurality of prior performers of the first task.

12. The device of claim 11, wherein the making of the second determination via the machine learning is further based upon the abstraction of the performance of the first task.

13. A non-transitory machine-readable medium comprising executable instructions that, when executed by a processing system including a processor, facilitate performance of operations, the operations comprising:
receiving from a first user device, via a first communication channel, a first visual representation of a first action performed by a first user;
receiving from a second user device, via a second communication channel, a second visual representation of a second action performed by a second user;
engaging in machine learning to determine:
whether, based at least in part upon the first visual representation, performance of a first portion of a sequential process has been completed by the first user; and
whether, based at least in part upon the second visual representation, performance of the first portion of the sequential process has been completed by the second user;
responsive to a first determination that the performance of the first portion of the sequential process by the first user has been completed, prompting an instruction provider to provide an indication of a next portion of the sequential process to be performed by the first user; and
responsive to a second determination that the performance of the first portion of the sequential process by the second user has not been completed, prompting the instruction provider to provide additional instructions to the second user to aid the second user in performing the first portion of the sequential process.

14. The non-transitory machine-readable medium of claim 13, wherein:
the operations further comprise sending to the first user device via the first communication channel the indication of the next portion of the sequential process to be performed by the first user, the indication of the next portion of the sequential process to be performed by the first user comprising first instructions as to how to perform the next portion of the sequential process, and the first instructions comprising first text, first audio, first video, or any first combination thereof; and
the operations further comprise sending to the second user device via the second communication channel the additional instructions, the additional instructions comprising more detailed instructions, relative to any instructions that had previously been provided to the second user, as to how to perform the first portion of the sequential process, and the additional instructions comprising second text, second audio, second video, or any second combination thereof.

15. The non-transitory machine-readable medium of claim 14, wherein:
the first communication channel comprises a first wireless communication channel, a first wired communication channel, or any first combination thereof; and
the second communication channel comprises a second wireless communication channel, a second wired communication channel, or any second combination thereof.

16. The non-transitory machine-readable medium of claim 13, wherein:
the first user device comprises a first desktop computer, a first laptop computer, a first tablet, a first smartphone, or any first combination thereof;
the second user device comprises a second desktop computer, a second laptop computer, a second tablet, a second smartphone, or any second combination thereof;
the first visual representation comprises a first image, a first plurality of images, a first video, or any third combination thereof; and
the second visual representation comprises a second image, a second plurality of images, a second video, or any fourth combination thereof.

17. The non-transitory machine-readable medium of claim 13, wherein the engaging in the machine learning further comprises generating an abstraction of a performance of the first portion of the sequential process, the abstraction of the performance of the first portion of the sequential process being based upon a plurality of prior performances of the first portion of the sequential process by each respective one of a plurality of prior performers of the first portion of the sequential process.

18. A method comprising:
receiving, by a processing system comprising a processor, a plurality of video feeds, each of the video feeds being provided by a respective one of a plurality of end user devices;
determining via machine learning by the processing system, for a first video feed of the video feeds, in which particular sequential process of a plurality of potential sequential processes a first user is engaged;
determining via the machine learning by the processing system, for a second video feed of the video feeds, in which particular sequential process of the potential sequential processes a second user is engaged, the particular sequential process in which the second user is engaged being different from the particular sequential process in which the first user is engaged;
prompting, by the processing system, a first instructor who is associated with the particular sequential process in which the first user is engaged to provide to the first user first instructions on how to perform a next stage of the particular sequential process in which the first user is engaged; and
prompting, by the processing system, a second instructor who is associated with the particular sequential process in which the second user is engaged to provide to the second user second instructions on how to perform a next stage of the particular sequential process in which the second user is engaged.

19. The method of claim 18, wherein:
the determining via the machine learning in which particular sequential process of the potential sequential processes the first user is engaged further comprises generating a first abstraction of a performance of the particular sequential process in which the first user is engaged, the first abstraction of the performance of the particular sequential process in which the first user is engaged being based upon a first plurality of prior performances of the performance of the particular sequential process in which the first user is engaged by each respective one of a first plurality of prior performers of the performance of the particular sequential process in which the first user is engaged; and
the determining via the machine learning in which particular sequential process of the potential sequential processes the second user is engaged further comprises generating a second abstraction of a performance of the particular sequential process in which the second user is engaged, the second abstraction of the performance of the particular sequential process in which the second user is engaged being based upon a second plurality of prior performances of the performance of the particular sequential process in which the second user is engaged by each respective one of a second plurality of prior performers of the performance of the particular sequential process in which the second user is engaged.

20. The method of claim 18, wherein:
each end user device comprises a respective desktop computer, a respective laptop computer, a respective tablet, a respective smartphone, or any respective combination thereof;
the plurality of end user devices comprises a first end user device associated with the first user and a second end user device associated with the second user;
the method further comprises sending, by the processing system, to the first end user device the first instructions, the first instructions comprising first text, first audio, first video, or any first combination thereof; and
the method further comprises sending, by the processing system, to the second end user device the second instructions, the second instructions comprising second text, second audio, second video, or any second combination thereof.
